(19) United States
(12) Patent Application Publication
(10) Pub. No.: US 2008/0298208 A1
(43) Pub. Date: Dec. 4, 2008

(54) OPTICAL HEAD AND OPTICAL DISC APPARATUS

(76) Inventors: Nobuyuki Maeda, Yokohama (JP); Hiromitsu Mori, Fujisawa (JP); Tomoto Kawamura, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/047,364

(22) Filed: Mar. 13, 2008

(30) Foreign Application Priority Data
Jun. 1, 2007 (JP) 2007-146427
Feb. 15, 2008 (JP) 2008-033947

(51) Int. Cl. G11B 7/00

(52) U.S. Cl. 369/110.01

(57) ABSTRACT

An optical head includes semiconductor lasers for 455 nm, 655 nm, and 785 nm bands; a polarization change element and a polarizing beam splitter for luminous flux with a wavelength of 455 nm band, a first collimation lens for converting luminous flux having passed through the polarizing beam splitter into parallel flux, a first quarter-wave plate, a BD objective for focusing the flux onto a signal recording surface of BD, a first photo-detector for receiving light reflected by BD, a composite prism for reflecting flux reflected by the splitter and transmitting most of flux from the lasers for 655 nm and 785 nm bands, a second collimation lens for converting flux emitted from the composite lens into parallel flux, a second quarter-wave plate, an objective compatible with HD DVD, DVD, and CD; and a second photo-detector for receiving light reflected by HD DVD, DVD, and CD.

### INCORPORATION BY REFERENCE

The present application claims priorities from Japanese applications JP 2007-146427 filed on Jun. 1, 2007 and JP 2008-033947 filed on Feb. 15, 2008, the content of which are hereby incorporated by reference into this application.

### BACKGROUND OF THE INVENTION

1. Field of the Invention

The present invention relates to an optical head and an optical disc apparatus.

2. Description of the Related Art

Optical disc apparatuses such as a Digital Versatile Disc (DVD) and a Compact Disc (CD) are broadly used as information recording and reproducing apparatuses having remarkable advantages such as contactless reading and writing, large capacity, high-speed access, and low-cost media. Recently, to record a large amount of information items, there have been developed high-density optical disc apparatuses conforming to standards other than those of the discs described above, for example, Blu-ray Disc (BD) using a laser for a wavelength of about 405 nanometer (nm) band and a High-Definition DVD (HD DVD).

In this situation, the market is longing for a compatible optical head conforming to the standards of DVD and CD as well as those of BD and HD DVD.

To cope therewith, JP-A-2006-268899 describes a compatible optical head for BD, HD DVD, DVD, and CD by employing a three-wavelength laser configured in one package including three lasers and a polarization state changing module. Also, JP-A-2006-24351, i.e. US2006/0002247, describes a compatible optical head for BD, HD DVD, DVD, and CD in which an optical path is changed by use of a Bragg grating.

### SUMMARY OF THE INVENTION

According to a first embodiment (FIG. 1) of JP-A-2006-268899 employing a three-wavelength laser, a blue laser uses a GaN substrate and a red laser and an infrared laser use a GaAs substrate, and hence it is not possible to produce a three-wavelength laser of monolithic type in which three lasers are disposed on one substrate. If the blue laser and monolithic two-wavelength (red and infrared) laser are arranged on one straight light, the light emission point of the blue laser is remarkably apart from that of the two-wavelength laser. This leads to a problem of occurrence of large aberration due to an optical characteristic of a compatible objective lens. Since the different substrates are fixed onto each other, the light emission points of the blue laser and the two-wavelength laser are considerably dispersed when compared with dispersion of the light emission point in the monolithic two-wavelength laser. There hence appears a problem that the light spot cannot be incident to the center of the light receiving plane disposed in a photo-detector. There also exists a problem that the three-wavelength laser is expensive due to low yield.

On the other hand, the light emission point of the blue laser may be arranged on the upper or lower side of the light emission point of the two-wavelength laser, not laterally on the side thereof. However, in this situation, the DPP method cannot be employed for the Tracking Error Signal (TES) detection due to the restriction of the arrangement of the light receiving plane in the photo-detector. In the configuration in which three wavelengths are fed to one photo-detector, it is not possible to obtain an advantage equivalent to that of the DPP method as in the BD system of the first embodiment, which will be described later, by splitting the reflection light reflected by an optical disc into a multiplicity of light beams. When eccentricity of the optical disc and the spindle motor is taken into consideration, since the ordinary push-pull method is not practical, it is required to employ a differential phase detection method (to be referred to as a DPD method hereinbelow) for the TES detection. In this case, according to the principle of the DPD method, it is not possible to cope with recording of signals on an optical disc and reproduction of signals on an optical disc including unrecorded areas. Therefore, when a three-wavelength laser is used, even if three light emission points are arranged in a two-dimensional manner, there exist a problem that the recording operation is not coped with, a problem of considerable dispersion of the light emission points, and a problem of the high price.

As above, there exists a problem in which when the three-wavelength laser is employed, the optical head described in JP-A-2006-268899 cannot cope with the recording operation.

According to JP-A-2006-24351, two objectives are arranged in an radial direction of an optical disc such that luminous flux from a blue laser is incident thereto in the radial direction. By use of a Bragg grating, a light path for the incident light is changed so that the luminous flux enters an objective for BD and an objective for HD DVD. In the configuration, reflection light from the optical disc is received by one photo-detector commonly used for BD and HD DVD.

Signals are recorded with a high density on BD and HD DVD, and hence various margins allowed for the optical head are more restricted when compared with those of optical heads for the CD and DVD. That is, for the optical head for BD and HD DVD, it is more difficult to secure the performance required for the head. Therefore, when producing a compatible optical head compatible with BD, HD DVD, DVD, and CD, it is essential to secure the characteristics associated with BD and HD DVD. However, the configuration described in JP-A-2006-24351 is attended with difficulties as below. First, the same collimation lens and the same detection lens are used for BD and HD DVD, neither the appropriate return-path magnification nor the appropriate detection-system magnification is obtained. Second, excepting the mirrors and the objectives, the same optical system is used for BD and HD DVD. Therefore, after either one of BD and HD DVD is assembled and is adjusted, it is not possible to adjust the optical system the other one thereof.

If the BD optical system is to be first adjusted and the adjustment is finished, HD DVD is set to an optimal state only by changing the light path in an ideal state. However, the ideal condition cannot be obtained in an actual system due to errors, for example, in dimensions of parts and refractive indices and assembly errors. Hence, even if the diffraction grating is adjusted for BD to obtain an optimal interval between three spots on the optical disc, the interval is not optimal for HD DVD. Also, even if the system is adjusted so that the optimal spot is incident to an ideal position of the photo-detector for BD, there occurs a phenomenon for HD DVD in which the optical spot is incident to a position apart from the ideal position of the photo-detector. As above, in the configuration of JP-A-2006-24351 in which BD and HD DVD share the same light path, the characteristics associated with BD and HD DVD cannot be easily secured.

It is therefore an object of the present invention to provide an optical head and an optical disc apparatus for recording and reproducing signals compatible with BD, HD DVD, DVD, and CD.

The object is achieved, for example, by appropriately devising the configuration and arrangement of lasers.

According to the present invention, there is provided an optical head and an optical disc apparatus for recording and reproducing signals compatible with BD, HD DVD, DVD, and CD.

### BRIEF DESCRIPTION OF THE DRAWINGS

FIG. 1 is a simple plan view showing a configuration of an optical system and a BD light path in an optical head according to the present invention.

FIG. 2 is a plan view showing a pattern of a polarizing diffraction grating mounted in a BD system of an optical head according to the present invention.

FIG. 3 is a plan view showing a pattern of a light receiving plane of a photo-detector for BD in an optical head according to the present invention.

FIG. 4 is a simple plan view showing a configuration of an optical system and an HD DVD light path in an optical head according to the present invention.

FIG. 5 is a plan view showing a pattern of a light receiving plane of a photo-detector for HD DVD, DVD, and CD in an optical head according to the present invention.

FIG. 6 is a simple plan view showing a configuration of an optical system and a light path for DVD and CD in an optical head according to the present invention.

FIG. 7 is a simple plan view showing a method of supplying each incident luminous flux in a slim optical head.

FIG. 8 is a simple plan view showing a second embodiment of an optical head according to the present invention.

FIG. 9 is a simple plan view showing a configuration of an optical head according to the present invention.

FIG. 10 is a plan view showing a pattern of a light receiving plane of a photo-detector for BD according to the present invention.

### DESCRIPTION OF THE EMBODIMENTS

Description will now be given of a concrete configuration of a first embodiment according to the present invention.

### First Embodiment

Description will now be given in detail of a first embodiment of the present invention. The first embodiment includes as an example an optical disc apparatus in which a compatible optical head for BD, HD DVD, DVD, and CD is mounted.

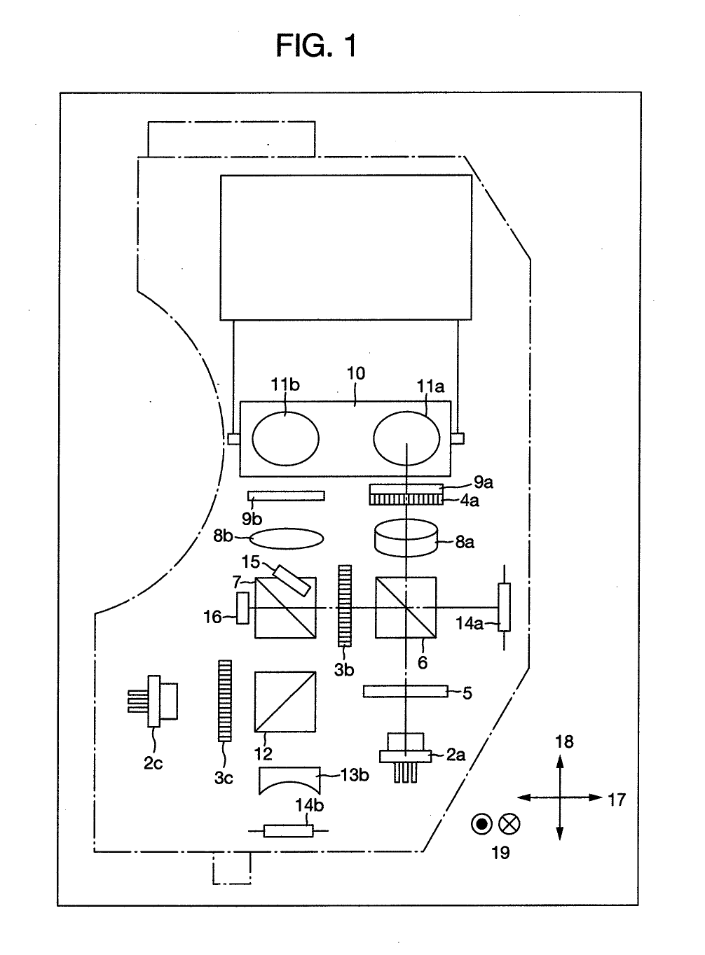

Referring now to FIGS. 1 to 3, description will be given of an optical system of BD. FIG. 1 shows structure of an optical head of the present invention in which the horizontal direction indicates a radial direction (tracking direction) 17 of the optical disc, the vertical direction indicates a tangential direction 18 thereof, and a direction perpendicular to the surface of the sheet of paper is a focusing direction 19.

From a semiconductor laser 2a, a diverging ray is emitted with a wavelength of about 405 nanometers (nm) and a polarization direction substantially parallel to the surface of the sheet of paper and enters a liquid-crystal (LC) element 5. The LC element 5 has a function, when applied with a drive voltage, to change the polarization direction of the incident luminous flux from a direction substantially parallel to the sheet surface to a direction substantially vertical thereto. If not applied with a drive voltage, the LC element 5 has a function to directly transmit the incident luminous flux without changing the polarization direction thereof. In the BD system of the optical head of the present invention, the LC element 5 is not applied with the drive voltage, and hence the incident luminous flux is transmitted therethrough and is emitted from the element 5 with the polarization direction kept unchanged. The flux then enters a Polarizing Beam Splitter (PBS) 6. Most part of the flux is a P-polarized light component and passes through the PBS 6. The remaining part thereof, i.e., an S-directional component is reflected by the PBS 6. It is assumed that the PBS 6 has Tp=98% and Rs=98%. The PBS has a characteristic to transmit therethrough almost 100% of the P-polarized component of the incident luminous flux and to reflect almost 100% of the S-directional component of the incident luminous flux.

The flux reflected by the PBS 6 is divided by a diffraction grating 3b into three beams of luminous flux of which the luminous flux incident to a composite prism 7 is reflected by the prism 7, the flux passing through a zone over the prism 7 directly propagates such that part thereof enters a front monitor 16. The monitor 16 is disposed to detect a change in intensity of laser light emitted from the semiconductor laser 2a. In operation, an output from the monitor 16 is fed back to the laser control circuit of the optical disc apparatus to thereby set the intensity of the light emitted from the laser 2a to a fixed value.

The luminous flux which has passed through the PBS 6 and which has a polarization direction parallel to the sheet surface is converted by a collimation lens 8a into substantially parallel flux of light. The lens 8a is attached onto a driver unit, not shown. By moving the position of the lens 8a in an optical axis direction 18, the output light flux is changed into substantially parallel light, less converging light, or less diverging light. In this configuration, by changing the quantity of spherical aberration of the optical spot focused onto an optical disc, it is possible to correct spherical aberration occurring due to the error in the substrate thickness of the optical disc.

The light flux emitted from the collimation lens 8a is incident to a polarizing diffraction grating 4a. The grating 4a serves as a diffraction grating if light flux incident thereto has a polarization direction vertical to the sheet surface. If light flux having a polarization direction parallel to the sheet surface is incident thereto, the grating 4a does not serve as a diffraction grating, but transmits the light flux therethrough. In this situation, since the incident light has a polarization direction parallel to the sheet surface, the grating 4a passes the light flux therethrough without causing diffraction thereof.

The flux of light delivered from the grating 4a enters a quarter-wave plate 9a to be converted into circularly polarized light, and then its propagation direction is changed by a mirror to a focusing direction 19. The light is focused by an objective 11a mounted on an actuator 10 onto a signal recording surface of BD. It is assumed that the objective 11a has a Numerical Aperture (NA) of 0.85 and is one glass lens dedicated to BD.

The flux of light reflected by the optical disc is incident to the objective 11a to be converted into substantially parallel light flux and is then reflected by a mirror, not shown, to be incident again to the quarter-wave plate 9a. The polarization direction of the light is changed by the plate 9a into a direction vertical to the sheet surface. The light flux outputted from the plate 9a enters the polarizing diffraction grating 4a to be separated into a plurality of light beams. The light beams from the grating 4a are converted via the collimation lens 8a into converging light. The light is reflected by the PBS 6 to enter a photo-detector 14a.

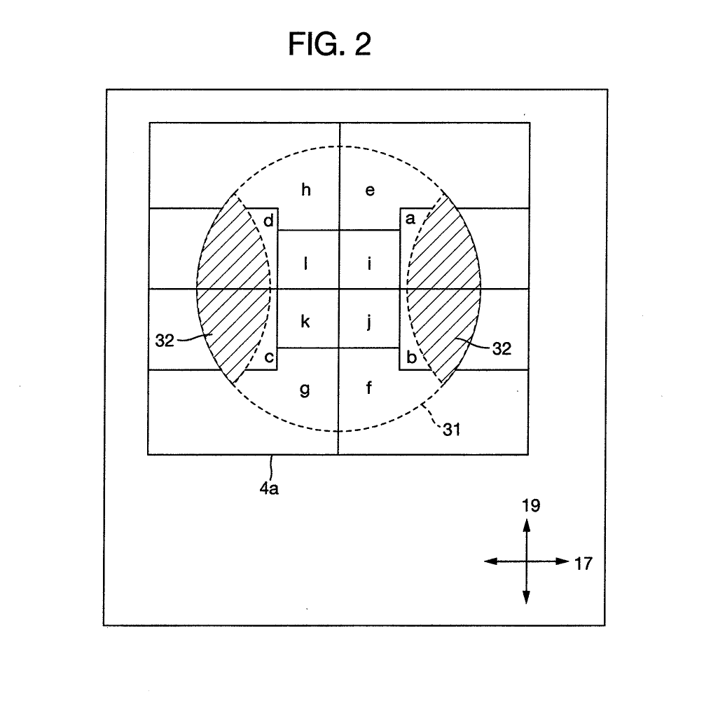

FIG. 2 shows a pattern of a grating formed in the polarizing diffraction grating 4a. The grating 4a includes 12 polarizing grating planes a to l. A dotted line 31 indicates a diameter of flux of light entering the grating 4a. A zone 32 surrounded by a two-dots-and-dash line and the dotted line 31 indicates a push-pull zone in which light of 0-th order and light of ±(1st order) overlap with each other, the light being reflected and diffracted by tracks of BD.

The flux of light which enters the grating 4a and of which the polarization direction is the focusing direction is separated respectively by the 12 polarizing grating planes a to 1 into light of ±(1st order), and hence 24 light beams are emitted therefrom. It is assumed that the intensity ratio between the light of +(1st order) and that of −(1st order) is one to five. In the configuration, there does not appear light of 0-th order.

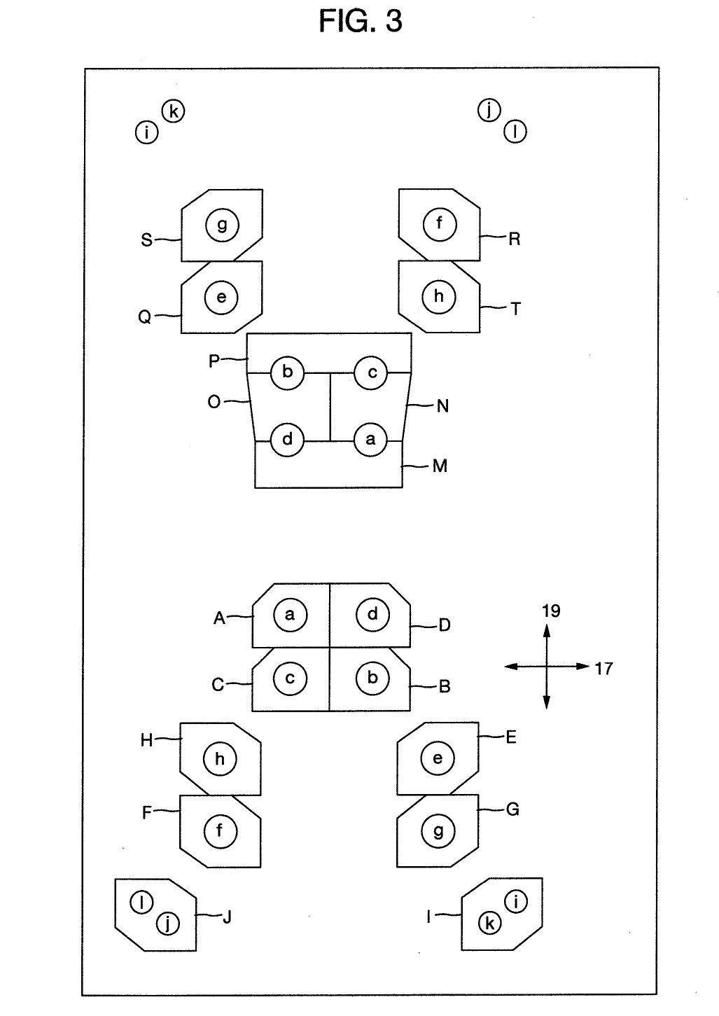

FIG. 3 shows a pattern of a light receiving plane of the photo-detector 14a including 18 light receiving planes. The light of −(1st order) diffracted by the grating 4a enters the light receiving planes A to J. The light of +(1st order) diffracted by the grating 4a enters the light receiving planes M to T.

In FIG. 3, a circle indicates a beam of light radiated onto each light receiving plane when the light is focused, and letters a to 1 indicates beams of light diffracted through the polarizing grating planes respectively assigned with the same letters shown in FIG. 2.

In the BD system of the optical head of the present invention, the focus error signal (FES) is detected using a knife edge method, and the modified DPP method and the DPD method are used for the TES detection by use of expressions as follows.

FES=(O+N)−(M+P)

TES={(A+B+E+F)−(C+D+H+G)}−Gain×{(Q+R)−(T+S)}

DPD={ph(A+C+E+G)−ph(B+D+F+H)}: Phase comparison

RF=A+B+C+D+E+F+G+H+I+J

wherein {(A+B+E+F)−(C+D+H+G)} substantially corresponds to the main push-pull signal. The sub-push-pull signal includes both components, i.e., the push-pull amplitude and the DC offset component associated with a lens shift. However, since the signal is incident to other than the push-pull zone as shown in FIG. 2, {(Q+R)−(T+S)} does not include the push-pull amplitude, namely, includes only the DC offset component associated with the lens shift. Therefore, in the expression of TES, even the term Gain×{(Q+R)−(T+S)} is subtracted, the push-pull amplitude does not become greater. By appropriately setting “Gain”, it is possible to cancel the DC offset component associated with the lens shift.

As above, according to the TES detection in the BD system of the optical head of the present invention, although only one spot is formed on the optical disc, there is obtained the same advantage as for the ordinary DPP method. It is hence possible to record signals on an unrecorded optical disk.

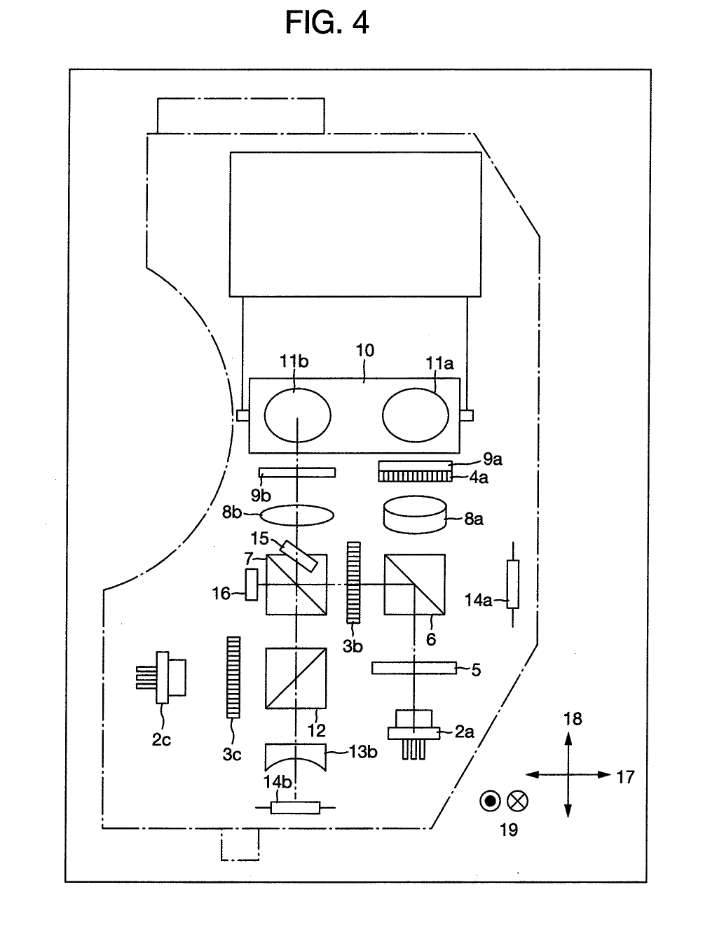

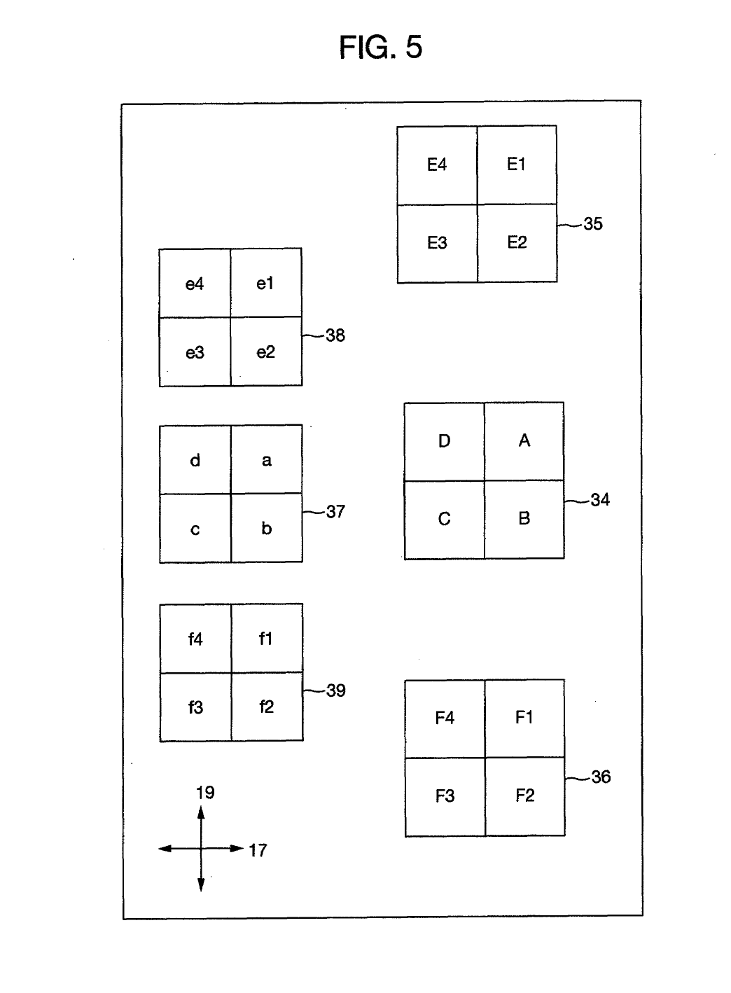

Referring next to FIGS. 4 and 5, description will be given of an optical system for HD DVD.

Diverging light which is emitted from the semiconductor laser 2a and of which the polarization direction is substantially parallel to the surface of the sheets of paper of FIGS. 4 and 5 is incident to the liquid crystal (LC) element 5 applied with a drive voltage. The polarization direction of the light is changed into the direction vertical to the sheet surface. Luminous flux emitted from the LC element 5 is incident to the PBS 6. Most part of the light, i.e., the S-polarized light component is reflected by the PBS 6. The reflected light enters the diffraction grating 3b to be divided into three beams of light, i.e., light beams of 0-th order and ±(1st order) for the TES detection using the DPP method. Most of the light from the grating 3b is incident to the composite prism 7, and about 100 percent thereof is reflected by the prism 7. For luminous flux having a wavelength of about 405 nm, the prism 7 has a characteristic of Tp=98% and Rs=98%. For luminous flux having a wavelength of about 655 nm and luminous flux having a wavelength of about 785 nm, the prism 7 has a characteristic of Tp=98% and Rs=98%, which will be described later. The light beam passing a zone over the prism 7 directly propagates, and part thereof enters the front monitor 16.

The luminous flux which is reflected by the prism 7 and of which the polarization direction is vertical to the sheet surface is converted through a collimation lens 8b into substantially parallel light. The light is then converted by a quarter-wave plate 9b into circularly polarized light. The plate 9b is a wide-band quarter-wave plate which serves as a quarter-wave plate not only for light flux having a wavelength of about 655 nm but also for light flux having a wavelength of about 785 nm.

The propagation direction of the light emitted from the plate 9b is changed by a mirror, not shown, to the focusing direction 19 and is focused by an objective 11b installed in the actuator 10 onto a signal recording surface of HD DVD. The objective lens 11b is an objective including one plastic lens compatible with HD DVD, DVD, and CD. For HD DVD light flux, the objective 11b has a characteristic of NA=0.65. The objective lens 11b is a lens of three-wavelength infinite type designed to obtain a predetermined characteristic for HD DVD, DVD, and CD light flux when collimate light flux is incident thereto. It is hence possible to receive the light flux of each of HD DVD, DVD, and CD by one photo-detector 14b.

The light reflected by the optical disc is converted via the objective 11b into substantially parallel light flux and is reflected by a mirror, not shown, to be incident again to the quarter-wave plate 9b. The polarization direction thereof is changed by the plate 9b to a direction parallel to the sheet surface. The light from the plate 9b is converted by the collimation lens 8b into converging light to pass through the composite prism 7 and the wide-band PBS 12 and is fed via a detection lens 13b to the photo-detector 14b.

FIG. 5 shows a pattern of a light receiving plane of the photo-detector 14b. The light receiving plane includes three four-partition detectors 34 to 36, which are generally used. However, since the optical head according to the present invention includes a two-wavelength laser in the DVD and CD systems, which will be described later, there are further arranged three four-partition detectors 37 to 39. Beams of light of HD DVD and DVD enter the three four-partition detectors 34 to 36, and beams of light of CD enters the three four-partition detectors 37 to 39.

In the HD DVD system of the optical head, an astigmatism method is employed for the FES detection, and the DPP method and the DPD method are used for the TES detection according to expressions as follows.

FES=(A+C)−(B+D)

TES={(A+D)−(B+C)}−Gain×{(E1+E4+F1+F4)−(E2+E3+F2+F3)}

DPD={ph(A+C)−ph(B+D)}: Phase comparison

RF=A+B+C+D

As above, since the DPP method is employed for the TES detection in the HD DVD system of the optical head of the present invention, it is possible to record signals in an unrecorded optical disc. Since the optical system of the optical head includes a collimation lens 8a for BD and a collimation lens 8b for HD DVD, it is possible to set an optimal optical magnification factor to each thereof. Also, the system includes a diffraction grating 4a for BD and a diffraction grating 3b for HD DVD. It is hence possible in the head assembly stage to set an optical position and an optimal angle to each thereof. Furthermore, since the system includes a photo-detector 14a for BD and a photo-detector 14b for HD DVD, it is possible in the head assembly stage to set each thereof to an optical position. Moreover, since one blue laser is employed for BD and HD DVD, there is provided a small-sized and inexpensive optical head.

According to the optical head of the present invention, high recording and reproducing quality is obtained for the BD and HD DVD systems.

In the optical head of the present invention, since the light flux passing through the PBS 6 is used for the BD system and the characteristics of the reflectivity and the transmittivity of the composite prism 7 are set as described above, the wide-band half-wave plate (HWP 2) used in the first embodiment (FIG. 1) of JP-A-2006-268899 can be dispensed with. According to the optical head of the present invention, by setting the reflectivity of the prism 7 to almost 100% for the HD DVD light flux, the light utilization efficiency is maximized in the HD DVD system.

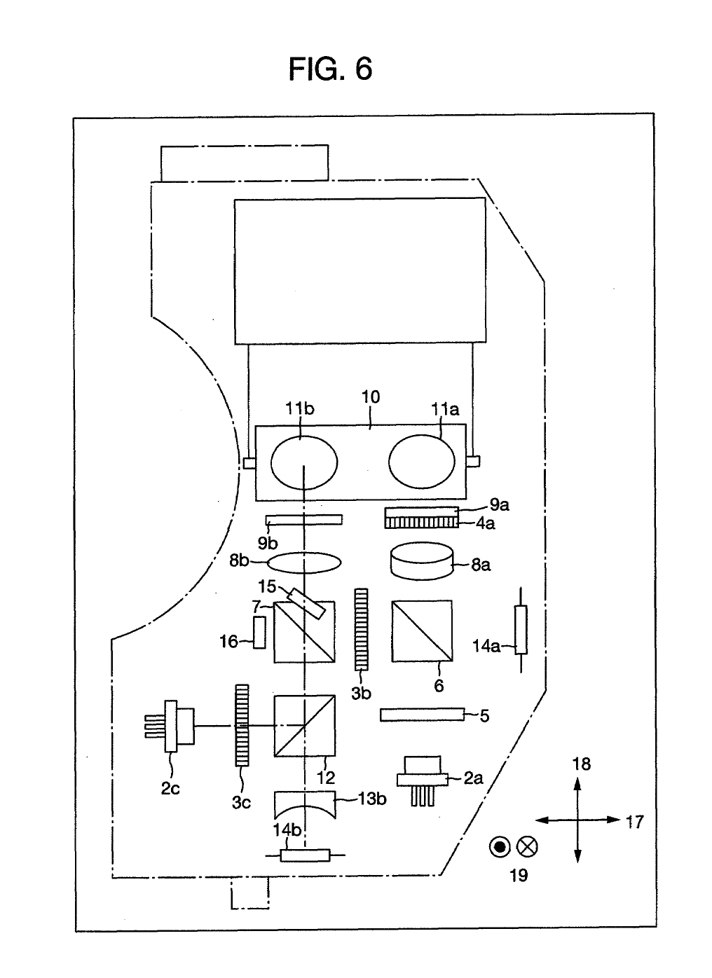

Referring now to FIG. 6, description will be given of an optical system for DVD and CD. In the optical head of the present invention, to reduce the number of parts for downsizing thereof, there is employed a two-wavelength laser 2c of monolithic type in which a semiconductor laser for oscillation of a frequency almost equal to 655 nm and a semiconductor laser for oscillation of a frequency almost equal to 785 nm are integrally formed on one substrate.

Diverging light which is emitted from the laser 2c with a frequency almost equal to 655 nm and of which the polarization direction is substantially parallel to the sheet surface of FIG. 6 is incident to a half-wave plate, not shown. The polarization direction is changed by the plate to a direction substantially vertical to the sheet surface. The half-wave plate is a wide-band half-wave plate which serves as a half-wave plate for luminous flux in a frequency band of about 655 nm and luminous flux in a frequency band of about 785 nm.

The luminous flux from the half-wave plate enters a wavelength selective diffraction grating 3c. For incident light having a wavelength of about 655 nm, the grating 3c separates the light into a light beam of 0-th order and light beams of ±(1st order) having a diffraction angle of θ1 relative to the light of 0-th order. For incident light having a wavelength of about 785 nm, the grating 3c separates the light into the light beam of 0-th order and light beams of ±(1st order) having a diffraction angle of θ2 relative to the light of 0-th order, θ2 being other than θ1. By appropriately designing the values of θ1 and θ2, the gap between the main spot and the sub-spot can be set to an optimal value on the optical disc for each of the DVD system and the CD system. By dividing the luminous flux into three light beams by the grating 3c, the TES detection can be conducted using the DPP method, and hence it is possible to cope also with the recording in the DVD and CD systems.

Almost 100% of the luminous flux from the grating 3c is reflected by the wide-band PBS 12. The PBS 12 has a characteristic of Tp=98% and Rs=98% for light beams respectively having wavelengths of about 405 nm, about 665 nm, and about 785 nm. In the configuration of the optical head of the present invention, Rs is not particularly designated for a wavelength of about 405 nm.

Almost 100% of the luminous flux outputted from the PBS 12 passes through the composite prism 7 to be converted via the collimation lens 8b into substantially parallel light flux. On the other hand, the luminous flux passing a position over the prism 7 directly propagates to be reflected by a reflection mirror 15, and part thereof enters the front monitor 16.

The light from the collimation lens 8b is converted via the quarter-wave plate 9b into circularly polarized light. The propagation direction of the light is bent by a mirror, not shown, to the focusing direction 19. The light is then focused by the objective 11b onto the signal recording surface of DVD. For the DVD luminous flux, the lens 11b has NA of 0.63.

The luminous flux reflected by the optical disc is converted by the objective 11b into substantially parallel light. The light is reflected by a mirror, not shown, to again enter the quarter-wave plate 9b. The polarization direction is changed by the plate 9b to the direction parallel to the sheet surface. The light from the plate 9b is converted via the collimation lens 8b into converging light. The light passes through the prism 7 and the PBS 12 to be fed via the detection lens 13b to the photo-detector 14b.

In the optical head according to the present invention, the luminous flux of the DVD system is incident to the light receiving planes 34 to 36 shown in FIG. 5 in the same way as for the luminous flux of HD DVD, the astigmatism method and the differential astigmatism method are used for the FES detection, and the DPP method and the DPD method are used for the TES detection.

Also, the luminous flux of the CD system passes through the light path similar to that of the DVD system and is fed to the photo-detector 14b. For the luminous flux of the CD system, the objective 11b has NA of 0.51. In the optical head according to the present invention, the luminous flux of the CD system is incident to the light receiving planes 37 to 39 shown in FIG. 5, the astigmatism method is used for the FES detection, and the DPP method and DPD method are employed for the TES detection.

As above, according to the optical head of the present invention, the DPP method is employed for the TES detection in the DVD and CD systems, and hence the optical head can cope with the recording.

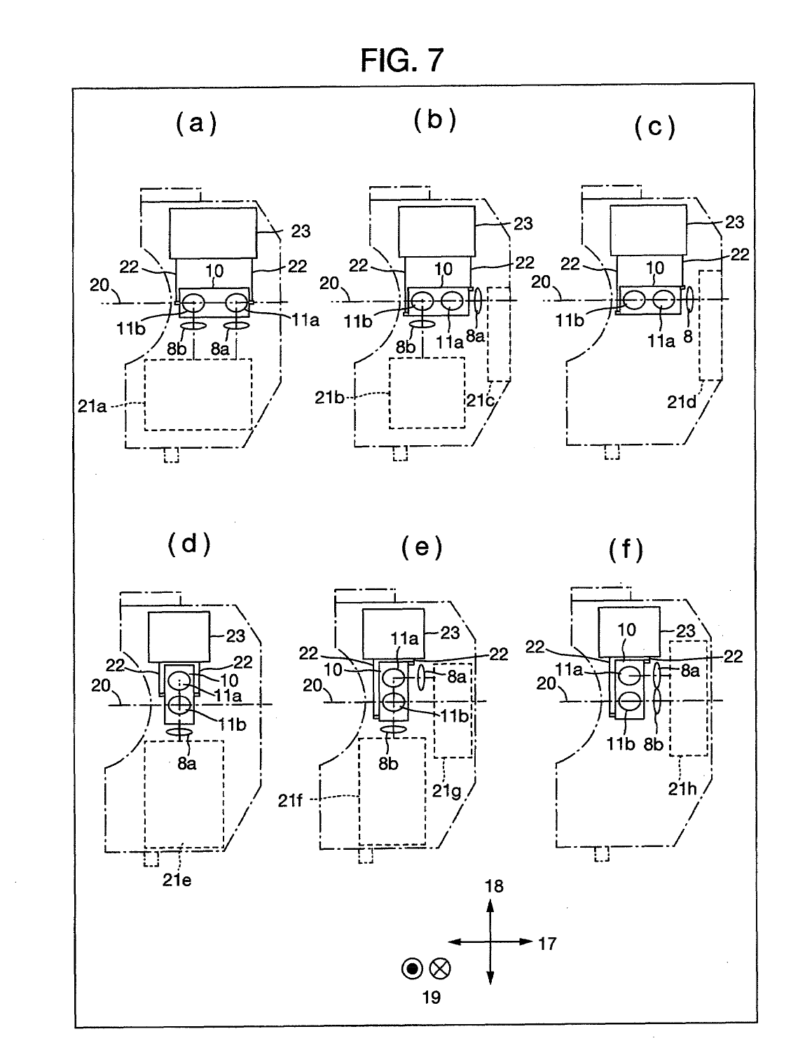

FIG. 7 shows an outline of arrangement of an optical system in a thin optical head (slim optical head) to be installed in a notebook-type personal computer.

Since the laser wavelengths employed for BD and HD DVD are substantially equal to each other, if one objective is shared therebetween, the light utilization efficiency lowers for BD and/or HD DVD, and hence at least either one thereof cannot be used for the recording purpose. Therefore, to cope with the recording for both of BD and HD DVD, it is required to mount an objective for BD and an objective for HD DVD on the optical head. In a situation to cope with the recording for DVD and CD in addition to BD and HD DVD, there are considered two methods, i.e., a three-objective method in which a DVD/CD compatible objective is added and a two-objective method in which an associated compatible function is provided for the BD objective and/or the HD DVD objective. In the first method, the volume and the weight of the required actuator are added to the total weight. It is hence difficult to secure the required acceleration and vibration characteristics. It is also difficult to mount the lens module on the slim optical head. Therefore, the optical head of the present invention employs the second method, i.e., the two-objective method.

In the two-objective method, four combinations are possible between the objective and an associated medium as shown in Table 1.

TABLE 1

| # | BD objective | HD DVD objective |
|---|---|---|
| a | — | DVD/CD |
| b | DVD | CD |
| c | CD | DVD |
| d | DVD/CD | — |

For BD, the value of NA is large, i.e., 0.85 and there also exists a problem regarding the temperature characteristic (increase in aberration with respect to a change in temperature), and hence it is difficult to produce a lens for BD using only one plastic lens. Therefore, a compound lens including two constituent lenses or a single glass lens is to be employed. Although it is technically possible to provide the single glass lens with compatibility with other media by arranging a diffraction grating on the glass, such glass lens with a diffraction grating is low in productivity and is hence quite expensive. Therefore, to provide the BD objective lens with compatibility as listed in rows b to d of Table 1, it is required to employ a compound lens including two plastic constituent elements (with the diffraction grating for compatibility) or a compound lens module including one glass les and a separate diffraction grating. In either cases, two constituent elements are used, and hence the objective becomes too thick to be mounted on a slim optical head.

On the other hand, the HD DVD objective has NA of 0.65 and can be formed using one plastic lens. Compatibility with DVD and CD can be hence provided by forming a grating for compatibility on a surface of the objective. Therefore, the optical head of the present invention adopts the configuration in row a of Table 1, namely, an objective including one glass lens dedicated to BD and a compatible objective including one plastic lens compatible with HD DVD, DVD, and CD.

Description will now be given of an arrangement of the objectives and the optical unit. Two methods are considerable to install the BD objective and the objective compatible with HD DVD, DVD, and CD on the slim optical head. First, the objectives are arranged in the radial direction 17 of the optical disc. Second, the objectives are arranged in the tangential direction 18 of the optical disc. In the first method, the objectives 11a and 11b can be arranged on an axis 20 extending in a direction to drive the optical head as shown in (a) to (c) of FIG. 7. Therefore, for BD, HD DVD, DVD, and CD, the first method is applicable to the ordinary DPP method using three spots. In contrast thereto, as can be seen from (d) to (f) of FIG. 7, at least either one of the objectives cannot be installed on the axis 20 according to the second method. If the ordinary DPP method is employed in this situation, there occurs a disadvantage on an off-centered side. That is, the angle of a track varies with respect to three spots between an inner circumference and an outer circumference. That is, the ordinary DPP method is not applicable in this case. In addition to these installation methods, there may be considered a method to install the two objectives along an inclined direction other than the radial direction 17 and the tangential direction 18. However, in this method, at least either one of the objectives is off-centered as in the second method, and hence the DPP method is not applicable.

In the slim optical head, an actuator movable section 10, an actuator fixed section 23, and a bar suspension 22 coupling these sections 10 and 23 with each other occupy almost half the space of the optical head. Therefore, it is required that the optical system is downsized to be installed in the remaining space of the slim optical head.

In the two-lens configuration, there may be employed a method in which luminous flux is incident to the lens in the tangential direction 18 as in (a) and (d), a method in which luminous flux is incident to the lens in the tangential direction 18 and the radial direction 17 as in (b) and (e), and a method in which luminous flux is incident to the lens in the radial direction 17 as in (c) and (f). It is not possible in the configurations of (c) and (f) to afford spaces to mount the respective optical units 21d and 21h. It is required to employ a special contour for the actuator such that the bar suspension 22 does not interrupt the incident luminous flux propagating in the radial direction 17. Therefore, the configurations of (c) and (f) are not suitable for the slim optical head. In the configurations of (b) and (e), although the spaces to mount the respective optical units are affordable, it is required to employ a special contour for the actuator as in (c) and (f). Moreover, two optical subunits 21b and 21c and two optical subunits 21f and 21g are respectively employed in (c) and (f). It is hence difficult to cope with BD and HD DVD by one blue laser, leading a problem that two expensive blue lasers are to be installed.

On the other hand, the configurations of (a) and (d) are advantageous in that the installation spaces of the optical units and the actuator performance can be easily secured. It is possible to cope with BD and HD DVD by using one blue laser.

However, in the configuration of (d), since the same light path is employed for BD and HD DVD as in the configuration of JP-A-2006-24351, it is difficult to secure the characteristics of BD and HD DVD. In contrast thereto, according to the configuration of (a), the system can be designed independently for BD and HD DVD, and hence it is possible to secure the characteristics of BD and HD DVD.

In the optical head according to the present invention, the lens 11a for BD and the compatible objective 11b for HD DVD, DVD, and CD are disposed in the radial direction 17 and luminous flux is incident thereto in the tangential direction. As a result, there is implemented a small-sized, inexpensive slim optical head.

Next, description will be given of an optical disc apparatus according to the present invention.

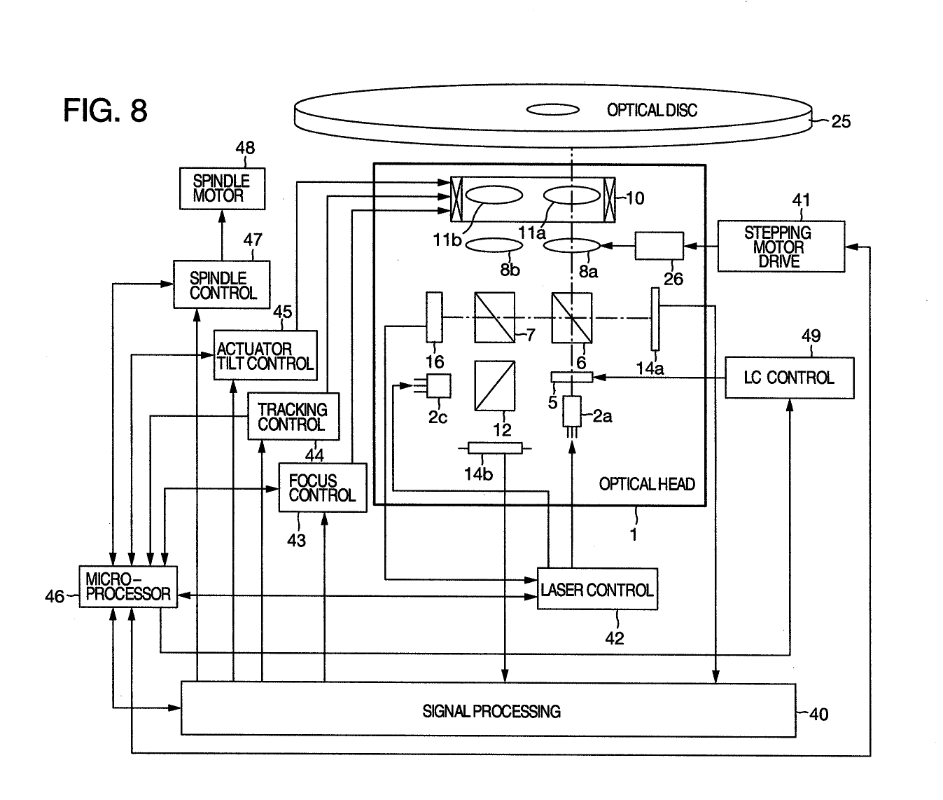

FIG. 8 shows an outline of structure of an optical head according to the present invention (for simplicity, the structure is represented in a two-dimensional image and parts of the optical head are not shown.) The optical head 1 of the present invention described above is installed in this optical disc apparatus. To avoid duplicated explanation, the optical head will be briefly described. Description will be given of the BD system in the optical head according to the present invention.

The optical head is a compatible optical head compatible with BD, HD DVD, DVD, and CD and includes one semiconductor laser 2a of a wavelength of about 405 nm and one two-wavelength laser 2c including a semiconductor laser of a wavelength of about 655 nm and a semiconductor laser of a wavelength of about 785 nm. On the actuator 10 of the optical head 1, there are arranged a lens 11a for BD and a compatible objective 11b for HD DVD, DVD, and CD in the radial direction of the optical disc. The actuator 10 is a tilt actuator which is movable in the focusing and tracking directions 19 and 17 and which is capable of tilting in the radial direction 17 of the optical disc. The optical head 1 also includes a photo-detector 14a for BD and a photo-detector 14b for HD DVD, DVD, and CD and a front monitor 16 for BD, HD DVD, DVD, and CD. The optical head 1 further includes a liquid-crystal element 5 to change a light path between the BD system and the HD DVD system and a stepping motor 26 to drive the collimation lens 8a in the direction of the light axis to correct spherical aberration in the BD system.

Luminous flux emitted from the laser 2a passes through the liquid crystal 5 and the PBS 6 and is then converted by the collimation lens 8a into substantially parallel luminous flux to be focused via the objective 11a onto the signal recording surface of a BD 25. Reflection light reflected by the optical disc 25 passes through the objective 11a and the collimation lens 8a and is reflected by the PBS 6 to enter the photo-detector 14a. The luminous flux is converted by the photo-detector 14a into an electric signal to be fed to a signal processing circuit 40. The circuit 40 receives the signal to detect, for example, a servo signal and a Radio Frequency (RF) signal.

The focus error signal (FES) created from the circuit 40 is supplied to a focus control circuit 43. The controller 43 generates and outputs therefrom a drive signal to drive the actuator 10. The objective 11a is hence driven in the focusing direction 19. Resultantly, focus control is implemented in the feedback loop. This keeps the optical head 1 retained in the focused state on the recording layer of the optical disc 25.

The TES produced from the signal processing circuit 40 is supplied to a tracking control circuit 44. The circuit 44 produces and outputs therefrom a drive signal of the actuator 10 to drive the objective 11a in the tracking direction. This achieves tracking control in the feedback loop and hence keeps the optical head 1 retained in the focused state on the recording layer of the optical disc 25.

The drive signal from the tracking control circuit 44 is also supplied to a thread control circuit, not shown. The circuit 44 creates a drive signal to control a thread motor, not shown, according to displacement of the objective 11a in the tracking direction and outputs the signal to the thread motor. The motor is hence driven to move the optical head 1 in the radial direction 17 of the optical disc 25.

The signal processing circuit 40 reads information of a rotation period from the disc 25 to supply the information to a spindle control circuit 47. Based on the information, the circuit 47 generates a signal to drive a spindle motor 48 and outputs the signal thereto. By feeding an output signal from the front monitor 16 back to a laser control circuit 42, intensity of emission light emitted from the laser 2a is kept fixed.

A microcomputer 46 conducts operation, for example, to initialize the circuit system. The microcomputer 46 also issues an instruction of on/off of a laser and an instruction of laser power of a laser to the laser control circuit 42. The microcomputer 46 instructs creation/non-creation of the drive signal to a drive circuit 41 of the stepping motor 26 to drive the collimation lens, open/close of a focus servo loop to the focus control circuit 43, open/close of a tracking servo loop to the tracking control circuit 44, and rotation/stop and a rotary speed of a spindle to the spindle control circuit 47.

When the microcomputer indicates an output voltage to an actuator tilt control circuit 45, the control circuit 45 applies a drive voltage to the actuator.

To change operation between BD and HD DVD, the microcomputer 46 indicates a liquid-crystal control circuit 49 to apply a drive voltage to the liquid crystal 5 or to remove the applied voltage therefrom. The liquid crystal 5 is not driven in the recording/reproducing operation of BD in the optical disc apparatus of the present invention. The liquid crystal 5 is driven in the recording/reproducing operation of HD DVD. Additionally, the liquid crystal 5 is not driven in the recording/reproducing operation of DVD or CD.

To conduct recording/reproducing operation for BD, the BD photo-detector 14a is set to an active state and the photo-detector 14b for HD DVD, DVD, and CD is set to a sleep state. To conduct recording/reproducing operation for HD DVD, DVD, or CD, the photo-detector 14a is set to a sleep state and the photo-detector 14b is set to an active state. According to the type of the optical disc and the operation mode, i.e., recording or reproducing, the gain is adjusted for each of the photo-detectors 14a and 14b and the front monitor 16.

As above, there is implemented a small-sized, inexpensive optical disc apparatus having satisfactory recording/reproducing quality for BD and HD DVD by using the optical head according to the present invention and by changing the drive voltage of the liquid crystal.

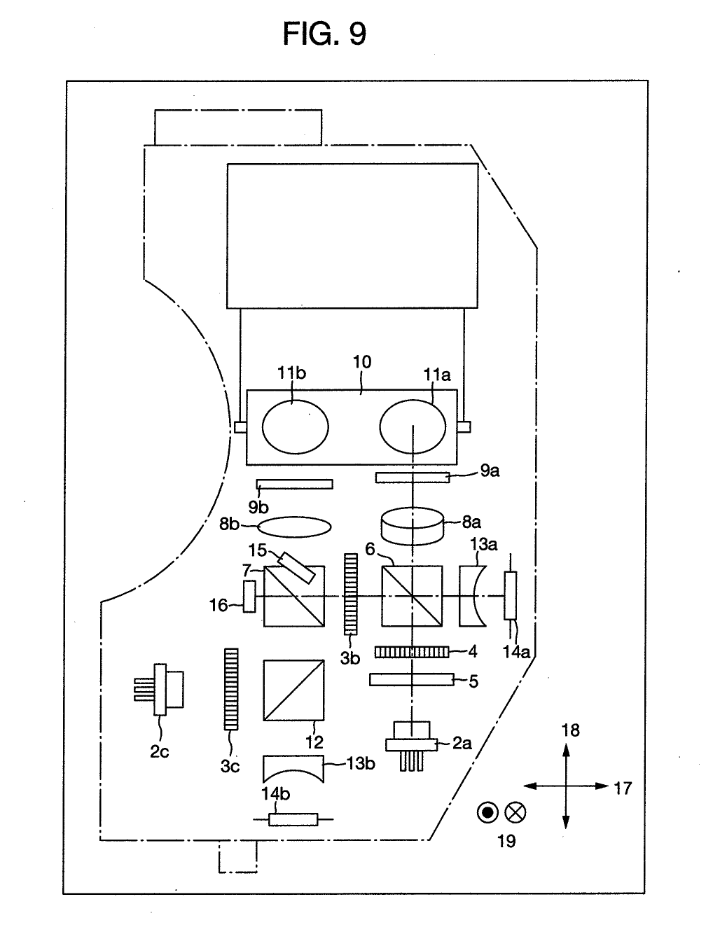

Next, description will be given of a second embodiment. FIG. 9 shows an optical system configuration of an optical head in the second embodiment according to the present invention. The optical system of the second embodiment differs from that of the first embodiment shown in FIG. 1 only in the BD system, and hence description will be given of the BD system.

Diverging light which is emitted from the semiconductor laser 2a with a wavelength of about 405 nm and a polarization direction substantially parallel to the sheet surface is incident to the liquid crystal 5. The liquid crystal 5 has a function, when applied with a drive voltage, to change the polarization direction of the incident luminous flux from a direction substantially parallel to the sheet surface to a direction substantially vertical thereto. If not applied with a drive voltage, the liquid crystal 5 has a function to directly transmit the incident luminous flux without changing the polarization direction thereof. In the BD system of the optical head of the present invention, the liquid crystal 5 is not applied with the drive voltage, and hence the incident luminous flux is transmitted through and is emitted from the element 5 with the polarization direction kept unchanged. The luminous flux enters a polarizing diffraction grating 4. The grating 4 serves as a diffraction grating if light flux having a polarization direction parallel to the sheet surface is incident thereto. The incident luminous flux is hence divided into at least three beams of light, i.e., light of 0-th order and light of ±(1st order). If light flux having a polarization direction vertical to the sheet surface is incident thereto, the grating 4 does not serve as a diffraction grating, but transmits the light flux therethrough. In the BD system, since the incident light has a polarization direction substantially parallel to the sheet surface, the incident luminous flux is hence divided into at least three light beams, i.e., light of 0-th order and light of ±(1st order) to enter the PBS 6. Most part of the luminous flux, namely, a P-polarized light component passes through the PBS 6, and the remaining part thereof, i.e., an S-directional component is reflected by the PBS 6.

In operation of the HD DVD system, the liquid crystal 5 is applied with a drive voltage and hence changes the polarization direction of incident light to a direction substantially vertical to the sheet surface. Therefore, the luminous flux incident to the grating 4 passes through the grating 4 and is reflected by the PBS 6 to enter the diffraction grating 3b. The incident luminous flux is divided by the grating 3b into at least three light beams, i.e., light of 0-th order and light of ±(1st order). That is, since the grating 4 serves as a diffraction grating dedicated to BD and the diffraction grating 3b serves as a diffraction grating dedicated to HD DVD, it is possible to conduct adjustment independently for each of the BD and HD DVD systems. In the optical head of the present invention, two objectives 11a and 11b are arranged in the radial direction 17 of the optical disc and the centers respectively thereof are aligned onto an axis extending from the center of the optical disc in the optical head driving direction. Therefore, the DPP method is available in the TES detection for BD, HD DVD, DVD, and CD.

Luminous flux from the PBS 6 with a polarization direction parallel to the sheet surface is converted by the collimation lens 8a into substantially parallel luminous flux. The lens 8a is attached onto a drive unit, not shown. Luminous flux from the lens 8a enters the polarizing diffraction grating 4a. Luminous flux from the grating 4a is incident to the quarter-wave plate 9a to be converted into circularly polarized light of which the propagation direction is bend by a mirror, not shown, in the focusing direction 19. The light is focused by the objective 11a mounted on the actuator 10 onto a signal recording surface of BD. Luminous flux reflected by the optical disc is converted by the objective 11a into substantially parallel luminous flux, which is reflected by a mirror, not shown, to enter again the quarter-wave plate 9a. The polarization direction of the light is converted by the plate 9a into a direction vertical to the sheet surface. Luminous flux from the plate 9a is converted via the collimation lens 8a into converging light and is reflected by the PBS 6 to be fed via the detection lens 13a to the photo-detector 14a.

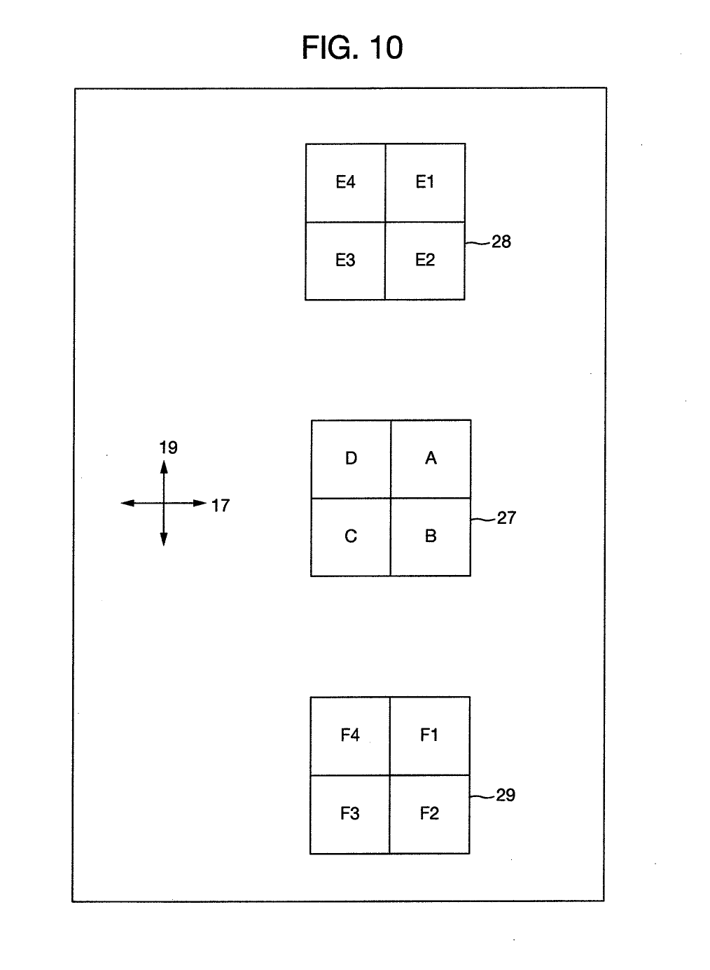

FIG. 10 shows a pattern of a light receiving plane of the photo-detector 14a. In the BD system of the optical head according to the present invention, the light receiving plane includes three four-partition detectors 27 to 29, which are generally used. The astigmatism method is employed for the FES detection, and the DPP and DPD methods are employed for the TES detection.

In the optical head of the present invention, the DPP method is available for BD, HD DVD, DVD, and CD. Therefore, the optical head is also capable of the recording for all media. There is provided a small-sized, low-cost optical head with high signal quality in the recording and reproducing operations for BD and HD DVD. The optical disc employing the optical head of the present invention can cope with operations including the recording for BD, HD DVD, DVD, and CD. There is also provided a small-sized, inexpensive optical disc apparatus having satisfactory recording and reproducing characteristics for BD and HD DVD.

Although the embodiments includes liquid crystal to change the polarization direction, there may be employed, in place of the liquid crystal, a unit to turn the half-wave plate or a unit to install and to remove the half-wave plate in and from the light path. In FIG. 1, in place of the arrangement in which the polarizing diffraction grating 4a is disposed between the quarter-wave plate 9a and the PBS 6, there may be used an arrangement in which a non-polarizing diffraction grating is disposed therebetween. However, in this situation, the effective diameter of the luminous flux incident to the grating becomes smaller. Therefore, the grating pattern, which is similar to that of FIG. 2, is reduced in size according to the reduction in the effective diameter. In the DVD/CD system, a laser for DVD and a laser for CD may be separately arranged in place of the two-wavelength laser 2c. In the optical system according to the present invention, optical elements such as a mirror to bend the light path and a liquid-crystal aberration correcting element may be additionally disposed according to necessity.

It should be further understood by those skilled in the art that although the foregoing description has been made on embodiments of the invention, the invention is not limited thereto and various changes and modifications may be made without departing from the spirit of the invention and the scope of the appended claims.

1. An optical head compatible with a Compact Disc (CD), a Digital Versatile Disc (DVD), a Blu-ray Disc (BD), and a High-Definition DVD (HD DVD), comprising:
a laser package including a laser light source for the CD and a laser light source for the DVD;
a blue laser light source for the BD and the HD DVD;
a first photo-detector for receiving light which is emitted from the blue laser light source and which is reflected by the BD; and
a second photo-detector for receiving light which is emitted from the laser package and which is reflected by the CD or the DVD and light which is emitted from the laser package and which is reflected by the HD DVD.

2. An optical head according to claim 1, further comprising:
polarization direction change means for changing polarization of light emitted from the blue laser light source;
a beam splitter for transmitting light having passed through the polarization direction change means and for reflecting the reflection light reflected by the BD; and
a composite prism for reflecting light having passed through the polarization direction change means and for transmitting the reflection light reflected by the HD DVD.

3. An optical head according to claim 2, further comprising:
a first objective for focusing light emitted from the blue laser light source onto the BD; and
a second objective for focusing light emitted from the laser package onto the CD and the DVD and light emitted from the blue laser light source onto the HD DVD, wherein
the first and second objectives are arranged in a radial direction of the disc.

4. An optical head, comprising:
a first semiconductor laser for emitting light having a first wavelength;
a second semiconductor laser for emitting light having a second wavelength;
a third semiconductor laser for emitting light having a third wavelength;
a polarizing beam splitter for receiving luminous flux emitted from the first semiconductor laser, the splitter transmitting most part of the luminous flux if the luminous flux has a polarization direction of P-polarized light, the splitter reflecting most part of the luminous flux if the luminous flux has a polarization direction of S-polarized light;
a polarization change element disposed between the first semiconductor laser and the polarizing beam splitter for changing a polarization direction of luminous flux incident to the polarizing beam splitter into either one of at least two states including substantially a polarization direction of P-polarized light and substantially a polarization direction of S-polarized light;
a first collimation lens for converting luminous flux having passed through the polarizing beam splitter into substantially parallel luminous flux;
a first quarter-wave plate for converting a polarization direction of luminous flux incident thereto into a polarization direction of substantially circularly polarized light;
a first objective for focusing the substantially parallel luminous flux onto a signal recording surface of a first optical disc;
a first photo-detector for receiving reflection light reflected by the first optical disc;
a composite prism for reflecting most of luminous flux reflected by the polarizing beam splitter and transmitting most of luminous flux emitted from the second semiconductor laser and the third semiconductor laser;
a second collimation lens for converting luminous flux emitted from the composite lens into substantially parallel luminous flux;
a second quarter-wave plate for converting a polarization direction of luminous flux incident thereto into a polarization direction of substantially circularly polarized light;
a second objective for focusing luminous flux having the first wavelength onto a signal recording surface of a second optical disc, focusing luminous flux having the second wavelength onto a signal recording surface of a third optical disc, and focusing luminous flux having the third wavelength onto a signal recording surface of a fourth optical disc; and
a second photo-detector for receiving reflection light reflected by the second, third, and fourth optical discs.

5. An optical head according to claim 4, wherein the first and second objectives are held by one actuator, the objectives being arranged in substantially a radial direction of the optical disc.

6. An optical head according to claim 4, further comprising a diffraction grating between the polarizing beam splitter and the composite prism for dividing the luminous flux having the first wavelength into at least three beams of luminous flux.

7. An optical head according to claim 4, further comprising a polarizing diffraction grating between the first quarter-wave plate and the polarizing beam splitter, the grating serving as a diffraction grating for dividing luminous flux if luminous flux incident to the beam splitter is S-polarized light and not serving as a diffraction grating flux if luminous flux incident to the beam splitter is P-polarized light.

8. An optical head according to claim 4, further comprising a polarizing diffraction grating between the polarization change element and the polarizing beam splitter, the grating serving as a diffraction grating for dividing luminous flux into at least three beams of luminous flux if luminous flux incident to the beam splitter is P-polarized light and not serving as a diffraction grating if luminous flux incident to the beam splitter is S-polarized light.

9. An optical head according to claim 4, wherein the composite prism reflects substantially all of luminous flux incident thereto if the luminous flux is S-polarized light having the first wavelength, transmits substantially all of luminous flux incident thereto if the luminous flux is P-polarized light having the first wavelength, and transmits substantially all of luminous flux incident thereto if the luminous flux is P-polarized or S-polarized light having the second or third wavelength.

10. An optical head according to claim 4, further comprising a wide-band polarizing beam splitter between the composite prism and the second photo-detector, the wide-band polarizing beam splitter having a characteristic for transmitting substantially all of luminous flux incident thereto if the luminous flux is P-polarized light having either one of the first to third wavelengths and reflecting substantially all of luminous flux incident thereto if the luminous flux is S-polarized light having either one of the first to third wavelengths.

11. An optical head according to claim 4, wherein the polarization change element includes liquid crystal, the polarization change element changing a polarization state of luminous flux incident to the polarizing beam splitter by driving the liquid crystal.

12. An optical head according to claim 4, wherein the second and third semiconductor lasers are installed in one package forming a two-wavelength laser.

13. An optical head according to claim 4, wherein:
the first wavelength belongs to a 405 nm band;
the second wavelength belongs to a 655 nm band;
the third wavelength belongs to a 785 nm band;
the first optical disc includes a protection layer having a thickness of about 0.1 millimeters (mm);
the second optical disc includes a protection layer having a thickness of about 0.6 mm;
the third optical disc includes a protection layer having a thickness of about 0.6 mm; and
the fourth optical disc includes a protection layer having a thickness of about 1.2 mm.

14. An optical disc apparatus, comprising an optical head, wherein the optical head comprising:
a first semiconductor laser for emitting light having a first wavelength;
a second semiconductor laser for emitting light having a second wavelength;
a third semiconductor laser for emitting light having a third wavelength;
a polarizing beam splitter for receiving luminous flux emitted from the first semiconductor laser, the splitter transmitting most part of the luminous flux if the luminous flux has a polarization direction of P-polarized light, the splitter reflecting most part of the luminous flux if the luminous flux has a polarization direction of S-polarized light;
a polarization change element disposed between the first semiconductor laser and the polarizing beam splitter for changing a polarization direction of luminous flux incident to the polarizing beam splitter into either one of at least two states including substantially a polarization direction of P-polarized light and substantially a polarization direction of S-polarized light;
a first collimation lens for converting luminous flux having passed through the polarizing beam splitter into substantially parallel luminous flux;
a first quarter-wave plate for converting a polarization direction of luminous flux incident thereto into a polarization direction of substantially circularly polarized light;
a first objective for focusing the substantially parallel luminous flux onto a signal recording surface of a first optical disc;
a first photo-detector for receiving reflection light reflected by the first optical disc;
a composite prism for reflecting most of luminous flux reflected by the polarizing beam splitter and transmitting most of luminous flux emitted from the second semiconductor laser and the third semiconductor laser;
a second collimation lens for converting luminous flux emitted from the composite lens into substantially parallel luminous flux;
a second quarter-wave plate for converting a polarization direction of luminous flux incident thereto into a polarization direction of substantially circularly polarized light;
a second objective for focusing luminous flux having the first wavelength onto a signal recording surface of a second optical disc, focusing luminous flux having the second wavelength onto a signal recording surface of a third optical disc, and focusing luminous flux having the third wavelength onto a signal recording surface of a fourth optical disc; and
a second photo-detector for receiving reflection light reflected by the second, third, and fourth optical discs.
